(19) United States
(12) Patent Application Publication
(10) Pub. No.: US 2003/0020758 A1
(43) Pub. Date: Jan. 30, 2003

(54) DYNAMICALLY ALTERABLE COMPUTER NETWORK BANNER AND METHOD OF USE

(76) Inventor: LARRY W. HINDERKS, RENO, NV (US)

Correspondence Address: ROBERT C RYAN, STARGUIDE DIGITAL NETWORKS INC, SUITE 1510, 300 E SECOND STREET, RENO, NV, 89509

(21) Appl. No.: 09/286,982

(22) Filed: Apr. 6, 1999

Related U.S. Application Data
(60) Provisional application No. 60/080,876, filed on Apr. 6, 1998.

(51) Int. Cl. G09G 5/00

(52) U.S. Cl. 345/809

(57) ABSTRACT

This specification discloses a system and method for providing dynamically alterable banners from content or web site servers to potentially thousands or millions of simultaneous clients on the Internet or other TCP/IP compatible intranet, LAN, or WAN computer network. The system utilizes the multicasting protocol to send UDP packets of banner text and other banner information to client web pages that, through HTML commands downloaded to the clients with a banner-enabled web page, have joined the multicast session for the banner associated with the downloaded web page. The system includes a unique protocol for utilization of the contents of the UDP packets by client web browser plugins that display the banner and its dynamically alterable content on the browser interface. The web meister or other operator can thus alter the contents of the banner dynamically and nearly continuously on both the head end or web server site and client site. The banners scroll either horizontally or vertically as the banner content is dynamically altered by the web meister and then multicast to all associated web pages running in conjunction with each client's web browser.

### CROSS-REFERENCE TO RELATED APPLICATIONS

This application is a continuation of, and claims priority through, the applicant's prior provisional U.S. patent application, Ser. No. 60/080,876, filed Apr. 6, 1998, entitled “Multicast Delivered Scrolling Banners.”

### FIELD OF THE INVENTION

The present invention relates to the delivery of advertising and other content through Internet and other networks of computers or similar data processing machines or systems. More particularly, this invention relates to the delivery through the Internet or intranets dynamically alterable text banners.

### BACKGROUND

Scrolling banners have long been utilized in the advertising, entertainment, and information industries in general. For example, billboard arrays of lights are often located along thoroughfares in order to display messages presented by illuminating lights in the array. The messages in the arrays can often be altered continuously by having an operator or perhaps a computer change the message to be displayed by the analog billboard array. People passing by the billboard array are thus exposed to messages that can be altered continuously or nearly so.

Television has also long utilized scrolling banners to present continuously or at least dynamically changing messages to viewers. Examples include: a “ticker banner” on the bottom of the television screen to present the viewer with continuously changing reports about the stock market; and a “remaining time banner” on a small portion of a television screen to inform viewers of the time remaining in the game being shown on the screen. These types of banners are broadcast as an integral part of the one television broadcast (i.e.,. the broadcast of the television screen signal) to the entire viewing audience.

For many years, however, the Internet has been a dominant means of delivering information, including entertainment content, to millions of people. Consequently, providers of content on the Internet have long been presenting various types of information, such as advertisements, to Internet users in the form of banners. Usually, however, the banners provided across the Internet have been “static” and thus not continuously or even relatively continuously alterable to change the message delivered to users after they have downloaded and are viewing or utilizing the web page(s) with which the banners are associated.

In this regard, today's web browsers usually communicate with a web server via a language called “HTML,” which is a “mark-up language.” The web site provider or manager, also called the “web meister,” typically develops the web page either by directly writing the code for the web page in the HTML language or by using a higher level tool for generating web page HTML code, such as the tool called “Front Page.”

HTML allows the development of web pages with text, graphics, and animated graphics. There is also an extension of the original HTML, called “Dynamic HTML,” allows easier animation of web pages. HTML can also be supplemented by additional “Plugins,” which allow programmers and web page designers to enhance the capabilities of web browsers beyond the capabilities provided by the originally-provided browser. There are a variety of plugin technologies available, including Netscape plugin technology, Microsoft Active-X technology, and the Sun Java technology. Through Dynamic HTML and plugins, web pages have been able to insert scrolling banners.

Typically, however, these HTML and plugin technologies have been utilized to generate banners for downloading to each user when the user receives the web page with which the banner is associated. At that point, however, the banner typically is no longer alterable to provide additional or changed information from the web server. In other words, the banner may continue to be displayed and to move or change in appearance while the Internet user is viewing the associated web page, but the overall content of the banner does not change after the banner has been downloaded to the user with the associated web page. If the user were to display the same web page for two hours, the overall banner usually provided by these technologies—the banner as delivered to the user at the commencement of the two hour period—would remain the same.

### BRIEF SUMMARY OF THE INVENTION

The applicant has developed a system and method for providing dynamically alterable banners through or in conjunction with the Internet or on intranets, LAN's, or WAN's. The applicant's system and method thus allow the web meister or other entity providing banner content to dynamically, and preferably continuously, alter the contents of one or more banners provided to multiple users or clients on the Internet, an intranet, a LAN, or a WAN.

The applicant has discovered that, using plugin technologies, a web meister can provide dynamically alterable banners through a point-to-point (full TCP/IP), cient/server application for banner delivery. In this client/server embodiment of a dynamic banner delivery system and method: (i) the client resides in the browser plugin; and (ii) the server, at the web-server site, sends banner contents, such as text, to the client. Certain content (e.g., text) in the banner is altered nearly continuously at the server or head-end for up to near continuous transmission of the altered content (text) to, and thus alteration of, each banner at each client that has a TCP/IP (point-to-point) connection with the server through the Internet.

The applicant has also discovered that, although the client/server embodiment provides a dynamically alterable banner on the client's workstation when accessing associated web pages, the client/server embodiment is not optimal, particularly when used on a large scale or in private Intranets, WANs, or LANs. For example, a client/server banner typically independently travels from the web or similar server to each client of the server (i.e., each viewer of the banner) through the one-to-one or point-to-point connection maintained between the server with each such client. If a given web site were to be viewed by many clients, the banner server for the site would be forced to engage in voluminous transaction and communication processing in order to send the changing banner content to all the clients through each one-to-one connection with each client of the server. For sites that serve a large number of clients who may simultaneously accessing a given web page, this voluminous processing would cause substantial delays in processing at the server. If the number of simultaneously-served clients-per-server exceeds several thousand (a very small number in the broadcasting and advertising world), the server can fail to keep up and process all clients within any reasonable amount of time. Since servers are expensive to install and maintain, it is not particularly helpful that the web meister might add servers to try to reduce the bottleneck created by the limited capabilities of a single server.

Another example is that, in the client/server embodiment, the changing banner content usually must travel through the Internet backbone independently for each client. This dynamic changing of content, through all the point-to-point connections for each and every client for every such banner, can cause a proliferation of Internet bandwidth consumption, which has long been a significant problem on the Internet as a whole. As more and web meisters or servers provide pages with dynamically alterable banners to their clients through such a point-to-point connection with of their associated Internet clients, the bandwidth congestion problems of the entire Internet become exacerbated.

These issues are likely to become of greater concern on private intranets, local area computer networks (LAN's), or wide area computer networks (WANs). In private intranets, LANs, and other types of private WANs, bandwidth can be particularly limited and precious. Placing the load of hundreds and perhaps thousands of continuously changing banners through as many one-to-one connections between the clients and the server would often consume too much bandwidth to even be permitted by the network administrator.

The applicant has invented a web server or other banner-providing embodiment sends the banner according to the multicasting protocol. Preferably, the web page associated with the banner includes an instruction for the user join the multicast group for the multicast banner and thus receive the multicast banner when the associated web page is being accessed or is open on the user's computer. The web page also preferably includes an instruction to leave the multicast group for the multicast banner when the associated web page is closed on the user's computer.

The web-page provider, such as the web meister, can thus provide dynamic content to those who are accessing the provider's web pages. Preferably, the web-page provider can continuously update or change the message or other aspect of the banner. In a particularly preferred embodiment, the web-page provider can provide a traditional web page along with multicasted video for viewing by a user on at least a portion of the web page, along with a continuously alterable banner on another portion of the web page.

It is to be understood, however, that the scope of the present invention is be determined by the accompanying claims and not by this brief summary of aspects of the invention.

### ADVANTAGES OF THE INVENTION

It is an advantage of the present invention that a content provider may alter the content of a banner provided in conjunction with a web page.

Yet another advantage of the present invention is that the content provider may delivery continuously or nearly continuously changing banners easily, economically, and often without the need for any special equipment.

It is another advantage of the present invention that the banner provider may “push” the banner content to a user or workstation accessing an associated web page (or similar structure) on the Internet or an accessible intranet, LAN, or WAN without waiting for the user or workstation to “pull” the content by, for example, re-downloading the web page and thereby the associated banner.

It is a still further advantage of the present invention that the preferred method of delivery of the banner does not require one-to-one, full TCP/IP connections between the content server and each user or client, thus reducing server processing, communication management, and bandwidth needs and consumption in order to deliver the dynamically changing banner to the users or clients. This reduction in processing, communication management, and bandwidth consumption can become dramatic as the number of users and clients grows.

Yet another advantage of the present invention is that it may provide along with a conventional web page a separate, dynamically changing banner message, advertisement, or series of advertisements that automatically terminate when the web page is no longer active on the user's workstation.

Another advantage is that it can be utilized to provide, on one portion of a browser screen or similar structure, additional and dynamic banner content while (i) yet another portion of the screen provides conventional, interactive web page content and (ii) a still further portion of the page provides separate streaming video content to the user.

An additional advantage of the present invention is that it may be utilized to deliver banners not only on the Internet but also in private intranets, LAN, and WANs.

A yet additional advantage is that, in the preferred embodiment, the computer code for the invention is trim, requiring minimal processing time on the workstation(s) running the code.

A further advantage is that the preferred embodiment provides banners that may scroll text messages horizontally or vertically, and the size, shape, and color of the banners and associated text also may be altered dynamically by commands received from the server.

Another advantage is that the preferred embodiment also ensures that the banner continues to display on the client even if changes or text messages are no longer being received from the server. The client thus continues to receive at least a certain amount of the message in the event that dropout or some other interruption takes place.

Yet another advantage is that the banner automatically adjusts to display changes in the banner at the rate they are received from the server.

These and other advantages of the present invention will become apparent as the specification proceeds. It is to be understood, however, that the scope of the present invention is to be determined according to the claims and not by whether a given embodiment achieves all advantages set forth in this listing of certain advantages of the invention.

### BRIEF DESCRIPTION OF THE DRAWINGS

The foregoing and other advantages are achieved by the applicant's preferred embodiment, which is shown in the accompanying Figures in which:

FIG. 1 is a sample client screen displaying separate, dynamically alterable horizontally and vertically scrolling banners;

FIG. 2 is the start-up screen for the preferred server application for dynamically altering banners provided by the server for Internet clients;

FIG. 3 is the server application screen for choosing a channel and sub-channel for multicasting of a particular banner for receipt by clients accessing web pages having banner HTML for joining the banner multicasting session;

FIG. 4 is a sample server application screen for choosing and dynamically altering a text message in a banner to be multicast by the server;

FIG. 5 is a sample dynamically alterable banner monitor displayed on the server screen upon sending of the multicast banner from the banner server; and

FIG. 6 is the server's color change screen, which is displayed upon activation of the color change button shown in FIG. 4, to control the color of the banner text and background.

### DETAILED DESCRIPTION OF THE PREFERRED EMBODIMENTS

The applicant's preferred embodiment consists of a software Netscape™ plugin for web browsers that allows the user to receive one or more dynamically and nearly continuously scrolling banners of text information. The preferred plugin responds to commands received from the server, including changes to the banner text message, text font, text point size, text color, background text color, and background color. The client plugin also adapts to the scrolling rate based on the rate at which characters are received from the server, and the client banner should therefore cease changing or scrolling when text changes are not being received from the server.

The applicant's preferred embodiment provides these functions in two different types of client plugins and two mating server applications. One client plugin, called “NpMsgBrd,” provides vertical scrolling of the banner message; and the other, called “NpMarKey,” provides horizontal scrolling. The respective server applications for these two client plugins are called “UpScroll” and “MarKey” respectively. The client plugins are built based on Netscape 3.0 plugin SDK, and the server applications are constructed using Microsoft 5.0 Visual C++.

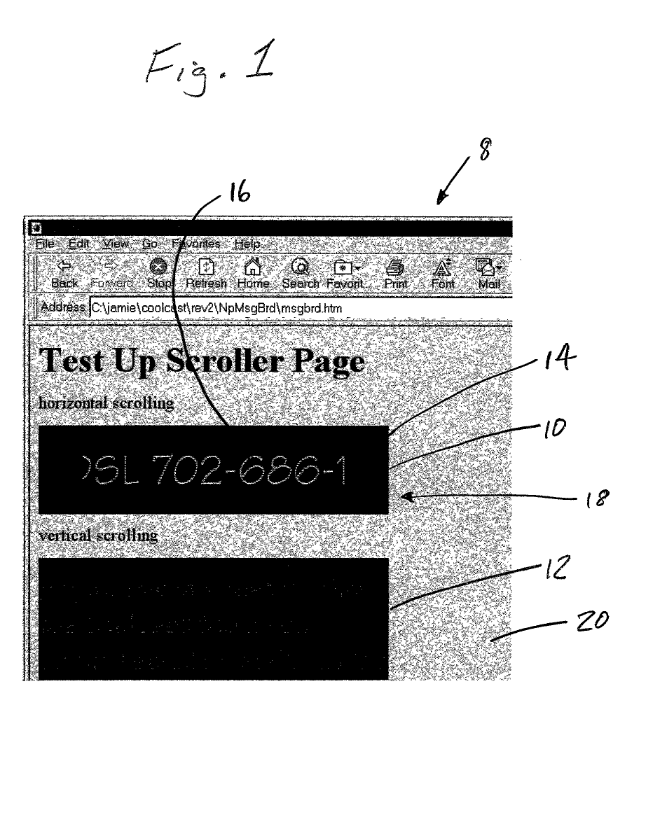

Referring now to FIG. 1, when the client browser, generally 8 (Microsoft Internet Explorer), receives a web page 20 and associated dynamic banners 10, 12 according to the sample preferred embodiment shown herein, the plugin NpMarKey yields a horizontally and dynamically scrolling banner 10, and the plugin NpMsgBrd yields a vertically and dynamically scrolling banner 12. Each banner, e.g., 10, consists of at least a banner background 14 and banner text 16 scrolling through the banner on a portion 18 of the client's browser screen 8 when the client is accessing a web page 20 associated with the banner, e.g., 10, as set forth in this specification.

The placement and size of the banners 10, 12 is determined by the banner HTML code for the web page 20. The web meister thus controls the placement and size of the banners 10, 12 for the associated web page 20 and transmits that information within the HTML for the web page 20 when the web server downloads the web page (HTML) 20 to the client web browser 8 across the Internet, intranet, LAN, or WAN.

The HTML code for the sample web page 8 is as follows:

<html><title> MESSAGE BOARD </title>
<h1> Test Up Scroller Page </h1>
<p> horizontal scrolling </p>
<embed src=junk.mky channel=1 subchannel=2 width=400
height=100> </embed>
<p><noembed>Your browser doesn't support plugins
: (</noembed></p>
<p> vertical scrolling </p>
<embed src=junk.ups channel=1 subchannel=2 width=400
height=150> </embed>
<p><noembed>Your browser doesn't support plugins
: (</noembed></p>
</html>

The above web page HTML code includes two embed statements. The first embed statement is used to insert the horizontal scrolling plugin, NpMarKey; and the second is for insertion of the vertical scrolling plugin, NpMsgBd, into the web page 20 that results from the web page HTML code.

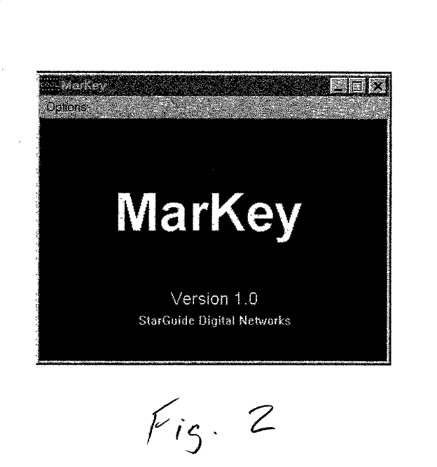

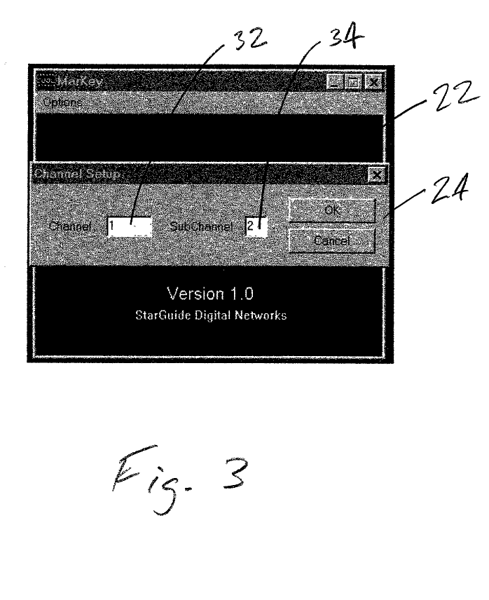

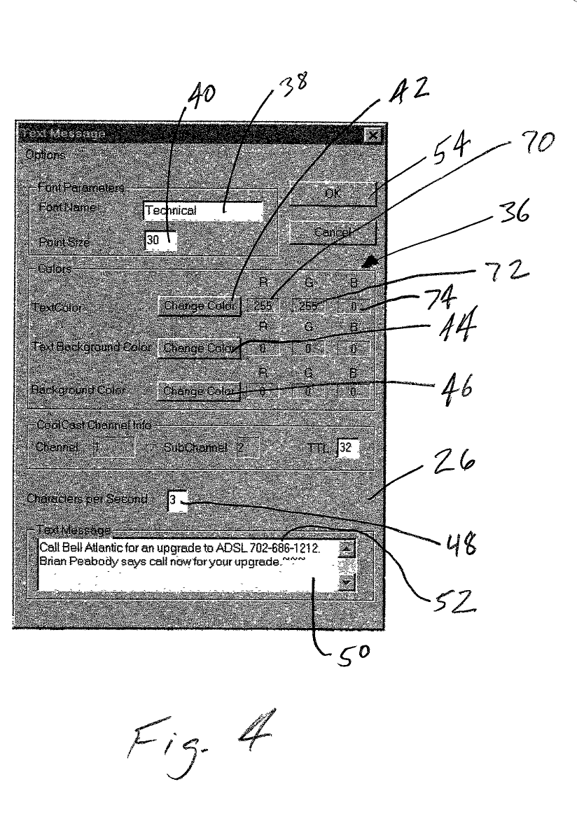

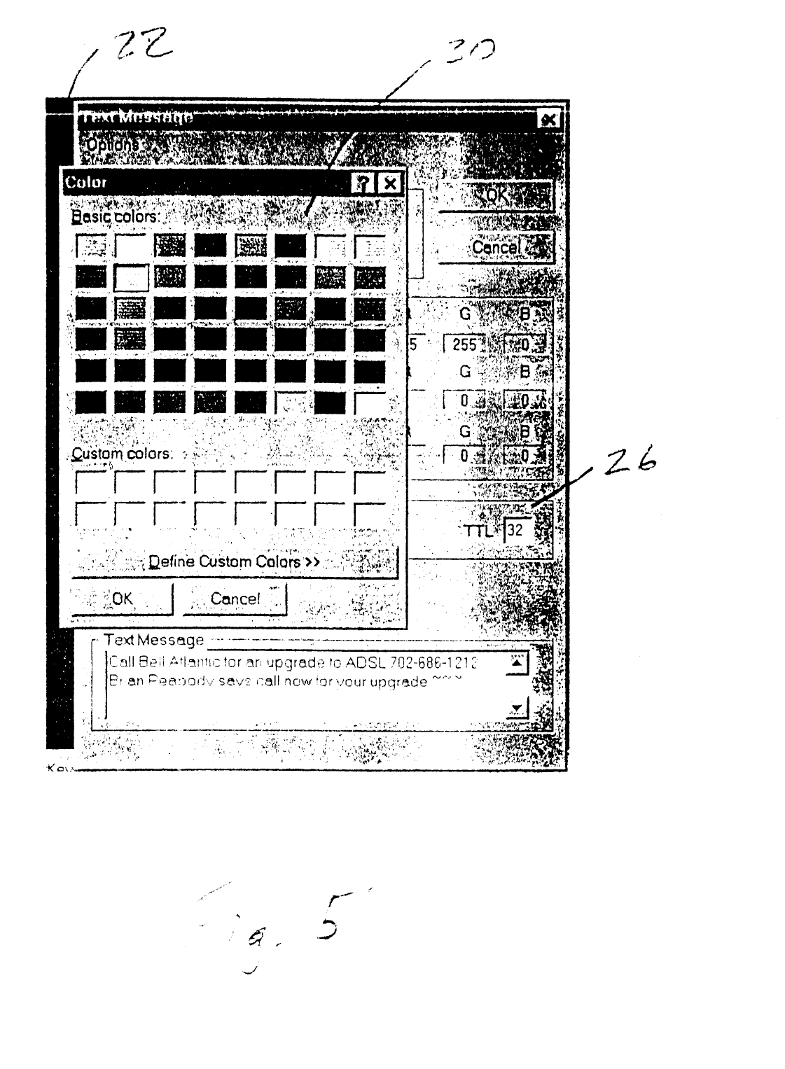

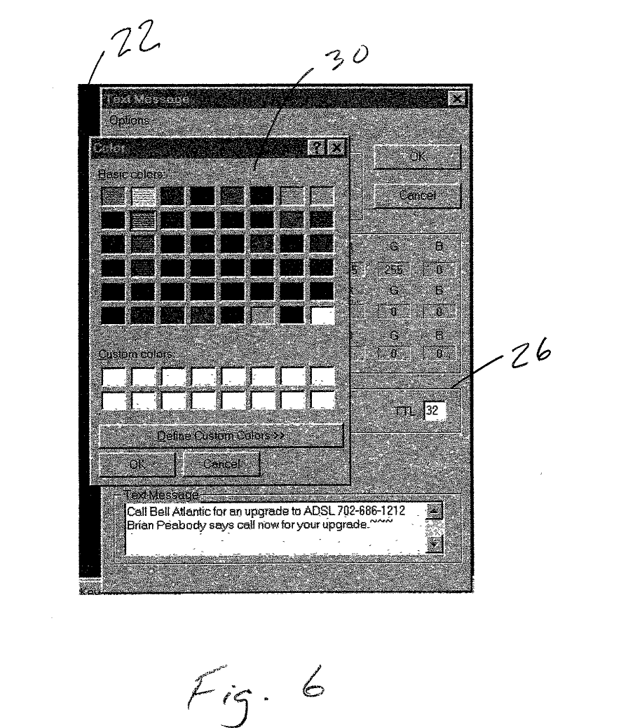

The Markey server application (for generating the horizontal scrolling banners) has a start-up screen 22 (in FIG. 2), a channel section screen 24 (in FIG. 3), a text message screen 26 (in FIG. 4), a server message monitor screen 28 (in FIG. 5), and a color selection screen 30 (in FIG. 6). The UpScroll server application (for generating the vertical scrolling banners) has similar screens performing similar functions but for vertical rather than horizontal scrolling of the text message to be generated in the banner according to the UpScroll application.

Referring now to FIG. 3, the channel selection screen 24 allows the web meister to select a channel 32 and sub-channel 34 for the banner being established through the Markey application 22. The Markey application 22 internally translates the selected channel 32 and sub-channel 34 into an IP address and a port. The resulting IP address is in the multicasting range of 224.0.0.0 to 239.255.255.255. The Markey application 22 thus prevents the web meister from inserting an incorrect address for multicasting of the resulting banner.

Referring now to FIG. 4, the text selection screen 26 allows the web meister to select banner characteristics, generally 36. These banner characteristics 36 include font type 38, point size 40, text color 42, text background color 44, background color 46, and character transmission (and thus banner character change) rate 48. The web meister also inserts the text message 50 through the text selection screen 26 by simply typing the message 50 in the message box 52 on the message screen 26. The web meister also enters the number “32” in the time to live (TTL) field on the message screen 26 to set the IP protocol time to the live parameter. The text message 50 is not sent to the client(s), however, until the web meister clicks on the OK button 54.

When the web meister clicks on the OK button 54, the Markey (or UpScroll application as the case may be) begins multicasting the text messages according to the selections, e.g., at the character rate 48, made by the web meister as described above. As shown in FIG. 5, the Markey application (or, again, the UpScroll application as the case may be) then brings up the server message monitor screen 28. The monitor screen 28 allows the web meister or other operator to view the number of UDP (multicast) packets 56 sent by the Markey application (or UpScroll) to the multicasting address (channel 58 and sub-channel 60) previously selected as described above (in connection with FIG. 3). The monitor screen 28 also provides a real time server banner 62 that allows the web meister or operator to view the dynamically scrolling banner 64 as it is being sent by the Markey (or UpScroll) application. The monitor screen 28 also provides a stop button 66, which the web meister or operator may click upon in order to immediately terminating transmission of the banner message 64 by the Markey (or UpScroll) application.

The web meister or operator may then alter the scrolling message 64 by clicking on the Options area 68 in the Markey base window 22 and, in the drop-down option bar that then appears (not shown but well known to those skilled in the art), click on the text message screen indicia that appears in the option bar. The Markey application then brings up the text message screen (26 in FIG. 4) so that the web meister or operator may type in a new message and then proceed to send it out as described above.

The multicast model and protocol was developed by Steve Deering, Ph.D., and is described in Internet RFC 1112. This protocol does not provide a standard for communication between a server and clients via multicast data streams. The applicant's preferred embodiment includes the applicant's unique Mbanner protocol to describe the scrolling banner content for dynamic use and display in client banner(s) by the web browser plugins, NpMarKey and NpMsgBd. The applicant's Mbanner protocol is based on a UDP (multicasting) packet sent from the Markey or UpScroll application to the client's NpMarKey and/or NpMsgBd application, respectively. TheMbanner-formatted UDP packet has a destination address in the multicast address range, and the UDP port number can be any number in the range from 0 to 65535 (16 bits). Each such UDP packet is then encapsulated by the IP protocol wrapper and delivered by the server to the computer network where it is routed via any of the various multicast routing protocols to clients (such as those running web pages with the HTML code as described above for joining the multicast address to which such UDP packets are multicast) by the computer network.

The Mbanner protocol is as follows:

| | | | | | | | |
|---|---|---|---|---|---|---|---|
| byte offset in packet | 0 | 1 | 2 | 3 | 7 | 9 | 9+n |

--------------------------------------------------------
----

| | |
|---|---|
| field description | \| Magic \| Ver \| Cmd \| BSN \| Len \| data \| |
| Magic \| | |

--------------------------------------------------------
----

| | | | | | | | |
|---|---|---|---|---|---|---|---|
| bytes used by field | 1 | 1 | 1 | 4 | 2 | n | 1 |

Magic = 0×fb a validity check number
Ver = 0×12 protocol version number
Cmd = 0×02 packet identifier (see below)
BSN = block serial number
Len = length of the data field
Data = the actual date being sent (see below)
Packet Identifiers:

Cmd = 0×02 Text
Len = number of text bytes in data field
Data = the text message (length given by Len)
Cmd = 0×08 Font
Len = number of bytes in font name (including 0 byte at end)

+ 1

Data[0] = point size
Data[1]..Data[n] = Font name terminated with a 0 byte
Cmd = 0×09 Background color of web page frame
Len = 3
Data[0] = Red value (0..255)
Data[0] = Green value (0..255),
Data[0] = Blue value (0..255)
Cmd = 0×0a Text face color
Len = 3
Data[0] = Red value (0..255)
Data[0] = Green value (0..255)
Data[0] = Blue value (0..255)
Cmd = 0×0b Text background color
Len = 3
Data [0] = Red value (0..255)
Data [0] = Green value (0..255)
Data [0] = Blue value (0..255)

The Mbanner protocol set forth above defines five different message types, each with its own command (cmd) byte. Three of the messages define a color based on the assumption, from the Microsoft Windows color descriptor, that the color is described on the client workstation by three values, each of which can range from 0 to 255 in a fashion well known to those skilled in the art.

The color descriptors within each UDP packet according to the Mbanner protocol are determined by the Markey (or UpScroll) applications through, as shown in FIG. 6, the color selection screen 30. This color selection screen 30 pops up automatically when the web meister clicks on, as shown in FIG. 4, any of the color buttons 42, 44, 46. The three values that apply to provide the color selected in the color selection screen 30 of FIG. 6 are automatically selected by the Markey (or UpScroll) application 22 and inserted into, as shown in FIG. 4, their respective one of three R, G, or B component color areas, e.g., 70, 72, 74, on the text message screen 26.

Because the MarKey and UpScroll server applications, and the NpMarKey and NpMsgBd plugins, are based on Microsoft Windows 95, the connection to the Internet or similar TCP/IP intranet, LAN, or WAN is through standard Windows Winsock routines.

The applicant's pseudo code for its MarKey application is as follows:

Get Channel and Sub-Channel from the user
Convert the channel and sub-channel into multicast IP
address and port
Connect to the Internet via Winsock routines
Set the time to live
Get text information from the user
Loop until the user depresses the stop key
Wait for the 2 second timer to tick

Based on the characters per second value, assemble a
buffer of characters and send with a Text packet id
(Cmd = 0×02)
Assemble a Font packet and send (Cmd = 0×08)
Assemble a Background color packet and send (Cmd =
0×09)
Assemble a Text face color packet and send (Cmd =
0×0a)
Assemble a Text background packet and send (Cmd =
0×0b)

End loop

The MarKey client plugin, NpMarKey, invokes various Windows Winsock routines to join the multicast group specified by the HTML for the web page downloaded to the client as described above. As explained above, this join operation requires an IP address and a port number. The particular address for the banner multicast address associated with the downloaded HTML (particular web page) received from the server is provided by a mapping from the channel/sub-channel information described in the embed tag in the downloaded HTML (web page) file described above. Once the join is accomplished, then the client on which the web page is active can receive any banner and associated messages from the server dynamically and up to nearly continuously (depending on whether the multicast messages incur any transmission delays) through the joined multicasting address and port.

The applicant's pseudo code for the client plugin NpMarKey is as follows:

Retrieve the channel and sub-channel from the embed
statement
Convert the channel and sub-channel into an IP address and
port number
Join the multicast group specified by the address and port
using Winsock routines
Loop while waiting for a multicast packet

Check for a magic byte at the beginning and end of
packet
Process the packet based on the command byte

End loop

The pseudo code for the client plugin NpMsgBrd is similar to that set forth above for NpMarKey.

Most preferably, the applicant's above-described dynamically alterable banner messaging system and method would be used in conjunction with the applicant's CoolCast™ Internet Video Broadcasting System and service. That service is presently available from StarGuide Digital Networks, Inc., Reno, Nev. It is described in detail in the applicant's co-pending and co-owned application, Ser. No. 08/969,164, filed Nov. 12, 1997, entitled “High Bandwidth Broadcast System Having Localized Multicast Access to Broadcast Content.”

It can thus be seen that the applicant has provided a system and method for sending dynamically alterable messages and other banner content to clients who view web pages associated with the banner. The web meister can thus send nearly continuously changing messages to the client and user viewing the client's web page. The messages can include advertising, general user information, or news such as sports scores, stock trading data, weather data, emergency warnings, recent late-breaking news stories, corporate messages (particularly on private intranets, LANs, and WANs) etc. Such messages or content preferably can be delivered from the server to the client without need for one-to-one, TCP/IP connections with each client and without placing large bandwidth demands on the computer network.

It is to be understood that the foregoing describes in detail the applicant's preferred embodiments. It is to be understood, however, that the scope of the present invention is to be determined by the accompanying claims.

I claim:

1. A text banner system for presenting a text banner on a portion of a computer page display generated on a plurality of client computers pursuant to downloaded computer page information, the text banner comprising in combination:
A. A computer page delivery application running on a content server on a computer network and being adapted to send out computer page information to other client computers on the network, the computer page information including a banner multicasting address and instructions to join a multicast broadcast of a banner message associated with the computer page information, whereby the banner message can be displayed on a portion of the computer page generated on the client computers pursuant to the downloaded computer page information; and
B. A text banner generating application running on the or another content server on the computer network and providing a banner alteration screen, whereby a text banner may be dynamically altered and multicast to the banner multicasting address for dynamic alteration of the banner message on the clients' computer pages.
